(19) United States
(12) Patent Application Publication
(10) Pub. No.: US 2011/0174165 A1
(43) Pub. Date: Jul. 21, 2011

(54) Food cage for barbeque grill

(76) Inventor: Miljko B. Todorovic, Laguna Niguel, CA (US)

(21) Appl. No.: 12/657,235

(22) Filed: Jan. 19, 2010

(51) Int. Cl. A47J 43/18

(52) U.S. Cl. 99/426

(57) ABSTRACT

A cage containing food is placed on a conventional cooking grill for cooking. The cage may be of various configurations, such as triangular or round, and is generally extended longitudinally on the grill. For the triangular configuration an apex of the cage is positioned downwardly through separated grid bars. The cage is formed of mesh-like material which precludes food from slipping through the bars of the grid and provides for more of the food to be simultaneously exposed to heat thereby providing more even and complete cooking.

### BACKGROUND

The background of the invention will be discussed in two parts.

1. Field of the Invention

The invention relates to barbeque grilling of food, and more particularly to food cages for use with a conventional grill.

2. Description of the Prior Art

Barbeque grills have grids used to support food above a source of heat, such as burning charcoal or a gas burner. The grills normally are formed of a plurality of equilaterally spaced linear rods secured on each end in a planar manner to a continuous side or to a circular rim. A search of the prior art has not disclosed the barbeque grill cages of the instant invention, however, an example of a portable cooker with a conventional grill is shown in U.S. Pat. No. 3,538,906 wherein the cooker includes a top kettle accommodating a one piece grate for combustible material, such as charcoal, and a cooking grill. In view of the prior art it is a feature of the present invention to provide new and unique food grilling cages for use with a barbeque grill for improved cooking of food.

### SUMMARY

The foregoing and other objects of the present invention are accomplished by providing food cages for use with a conventional, or slightly modified, cooking grill. The cages are formed of mesh-like material and may have open or closable ends. The cages may be rotated in any suitable manner for different exposure of the food to the cooking source of heat, thereby obviating the need to turn over individual pieces of food. The cages are generally extended longitudinally and may be of various configurations, such as triangular or round. Multiple configurations of the cages may be simultaneous used with the grill for providing improved cooking of different foods. The foregoing and other objects, features and advantages of the invention will become readily apparent from a reading of the specification when taken in conjunction with the drawings in which like reference numerals refer to like elements in the several views.

### DRAWINGS

FIG. 1 is a perspective view of an embodiment of the cooking cage in a laid open position in accordance with the invention;

FIG. 2 is a perspective view of the embodiment if FIG. 1 folded and latched to form an elongated triangular cage for enclosing food for cooking with a barbeque grill;

FIG. 3 is a is a perspective view of the cage as shown in FIG. 2 rotated to position an apex of the closed container downwardly preparatory to mounting to a grill;

FIG. 4 shows the cage of FIG. 3 having a handle and indicating placement of the cage upon a modified barbeque grill;

FIG. 5 illustrates placement of the cage of FIG. 3 onto the modified grill;

FIG. 6 is a perspective view of another embodiment of the invention indicating placement of the embodiment onto a barbeque grill; and

FIG. 7 indicates radiation of heat within the cage in accordance with the invention.

### DESCRIPTION

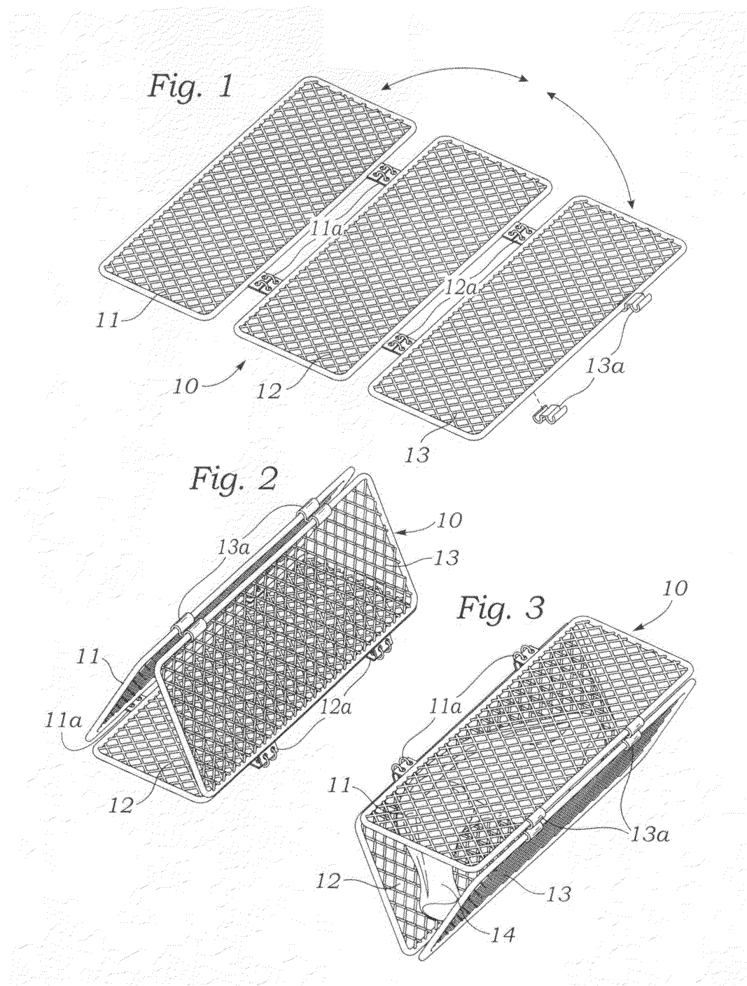

Referring to the drawings in general, and initially to FIG. 1, there is shown a cooking cage, generally designated 10, in accordance with a preferred embodiment of the invention. Cage 10 is shown comprised basically of three longitudinal planar sides, designated 11, 12, and 13 respectively. As shown, the sides 11-13 are generally rectangular and comprised of a mesh-like network of latticed crisscrossed metal material surrounded by a rectangular metal border. In addition to other advantages, as will be described, any food contained within the mesh-like cage 10 is precluded from slipping from the cage 10 and thus through the rods, or bars, of the grid as is often the case of cooking with a conventional grill. Although described as being of metal, the sides 11-13 may be of any suitable non-toxic material having the necessary requirements for cooking on a grill.

As seen, one edge of side 11 is pivotally connected to a first edge of side 12 by hinges 11a (two shown), the other edge of side 12 pivotally connected to a first edge of side 13 by hinges 12a (two shown). The other edge of side 13 includes clips, or latches, 13a (two shown) for connecting to the other edge of side 11 when sides 11 and 13 are folded upwardly as indicated in FIG. 1. Although the means for pivotally connecting sides 11 and 13 are described as hinges, any suitable means having the required connective and foldable characteristics may be used. Similarly, the described means for latching sides 11 and 13 may be of any suitable configuration that provides the necessary features.

FIG. 2 is a perspective view showing sides 11 and 13 pivotally folded and latched to form the elongated triangular cage 10 of the invention. Although the cage is shown having open ends, it is to be understood that one or both ends may be closed either with fixed or open and shut ends. Additionally, although the preferred embodiment is shown and described as triangular with three separate sides, the triangular cage could be formed as one piece.

FIG. 3 is a perspective view of the triangular cage 10 as shown in FIG. 2 rotated to position an apex pointing downwardly for placement of the cage 10 on the grid of a modified barbeque grill, generally designated 16, as will be explained. As shown, the food 14 is placed within the cage 10 during cooking and thus precluded from slipping through the grid bars as is the case with a conventional barbeque grill.

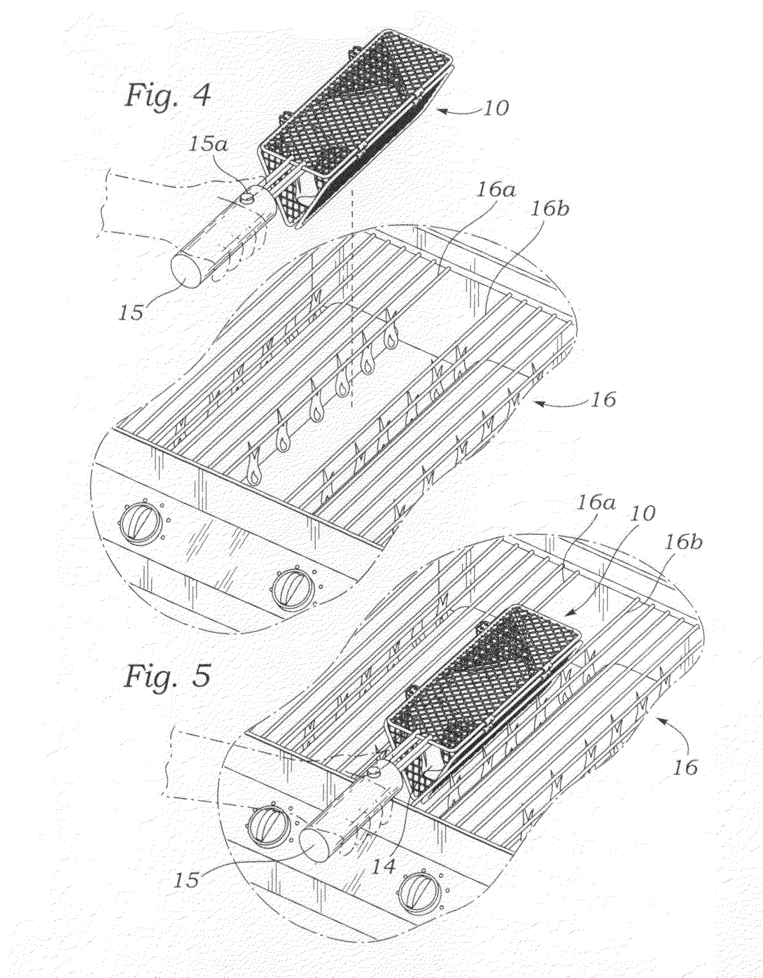

FIG. 4 indicates placement of the cage 10 upon the grill, generally designated 16, grill 16 shown with grid bars 16a and 16b separated for providing space for accepting an apex of cage 10. As seen, the apex is pointing downwardly for placement between bars 16a and 16b of grill 16, bars 16a and 16b separated a distance less than the width of the side of cage 10 that is opposite the apex so that the cage 10 cannot slip down between the bars 16a, 16b. Handle 15 is shown for manually grasping cage 10 for desired placement on the grill 16. Handle 15 is preferable configured for grasping and release by means of a button 15a, although any suitable means for grasping and release of the cage 10 may be used.

FIG. 5 illustrates placement of an apex of triangular cage 10 down between bars 16a and 16b as described. It is seen that the apex of the triangular cage 10, as well as a significant portion of the cage 10, is slipped down between the grid bars 16a, 16b, however, as is described the cage 10 cannot slip completely between the grid bars of the barbeque grill. This orientation of the triangular shaped cage 10 provides that heat will radiate directly into the cage sides adjacent to the apex that has been placed between the bars 16a, 16b of the grill 16.

The cage 10 need not protrude below the grill 16 as described but may be laid directly onto the grill 16. In this manner the cage 10 may be raised from the grill 16 and rotated to present a different side to the source of heat. Although the heat will radiate directly only into one side of the cage 10, heat will still radiate inward from all sides to provide co-active radiation to provide improved and more efficient cooking of food 15. It will as well contain the food 15 within the cage 10 as previously discussed.

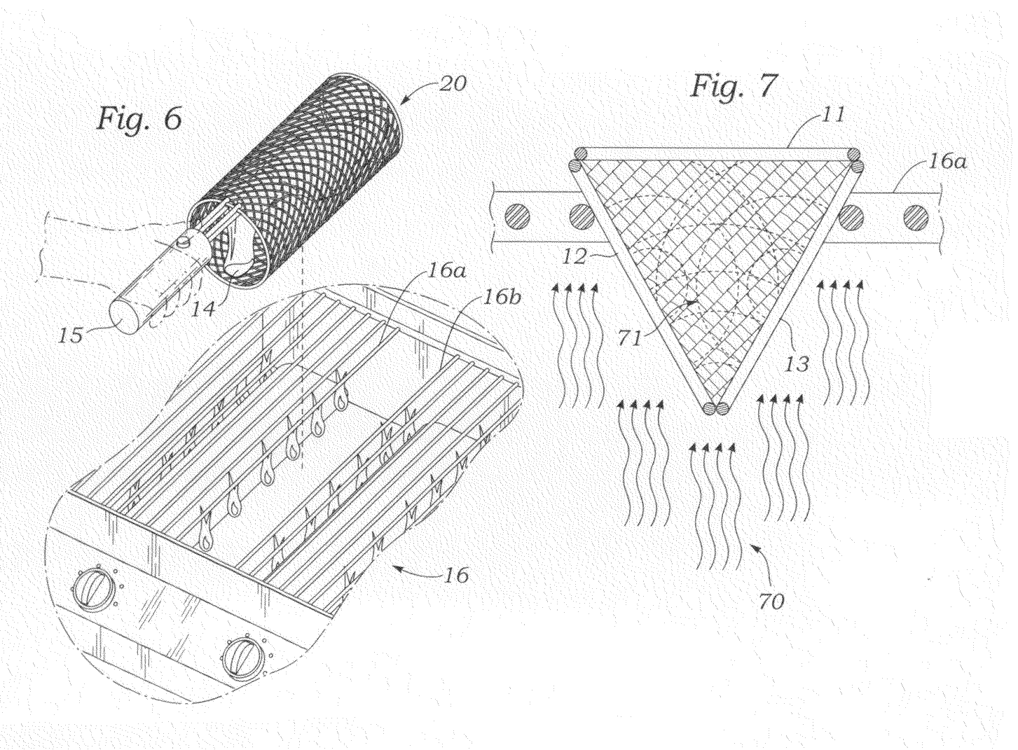

FIG. 6 is a perspective view of another embodiment of the food cage in accordance with the invention. Shown is a longitudinally extending circular food cage, generally designated 20, and indicated is the manner of placement of the cage 20 onto the barbeque grill 16. For placement similar to that of the cage 10, the grill bars 16a, 16b are separated a distance less than the diameter of the circular cage 20. Because of the circular configuration of the cage 20, and its placement between the bars 16a, 16b, more of the food 14 is exposed directly to heat thereby providing more even and complete cooking. The food 14 is also exposed to coactive heat radiating inwardly from the circular arc. The embodiment may as well be placed on the surface of the grill 16, without separation of the bars 16a, 16b, and rolled as desired for cooking of the food 14.

FIG. 7 illustrates the manner in which heat, generally designated 70, is applied to two sides of the triangular cage 10, and the manner in which coactive heat radiates within the cage 10, shown in dotted lines and generally designated 71, by means of inward radiation from the sides 11-13 of cage 10. This co-active radiation provides more even, quicker, and complete cooking of food within the cage 10. The cage 10 may be rotated to merge a different apex with the grill. It is to be understood that even though the triangular cage 10 is shown as having an equilateral configuration, the sides 11-13 may be of different widths.

The grill 16 may have separations other that as described for rods 16a and 16b for accepting other devices or accessories for partial insertion into selected rod separations. The grill 16 can be adapted for use with other than barbeque usage, such as for commercial cooking, where the concepts of the instant invention are desired.

There has been shown and described food cages for use with a conventional cooking grill. Although a preferred embodiment has been shown and described, it is to be understood that various modifications may be made within the spirit and scope of the invention.

What is claimed is:

1. An assembly for supporting food for cooking with a cooking grill comprising:
a food cage formed of mesh-like material for receiving said food, said mesh-like material configured to prevent fall-out of said food from said cage;
said cooking grill having a planar grid with linear rods for supporting said food; and
said cage is configured to be placed between selected rods of said grid whereby a portion of said food cage is positioned below the plane of said grill.

2. The assembly of claim 1 wherein said food cage has a triangular cross section.

3. The assembly of claim 2 wherein during cooking an apex of said triangular cage is positioned between a pair of said rods of said grid thereby positioning a portion of said triangular food cage below the plane of said grill.

4. The assembly of claim 1 wherein said food cage has a circular cross section.

5. The assembly of claim 4 wherein during cooking a portion of said circular cage is positioned between a pair of said rods of said grid whereby a portion said circular food cage appears below the plane of said grill.

6. An assembly for use with a cooker having a flat grid with linear rods for supporting food, comprising:
an elongated food cage for receiving said food and placement on said grid;
said food cage formed of a mesh-like material configured to prevent fall-out of said food from said cage; and
said cage configured to expose an increased portion of said food to heat provided by said cooker to thereby provide more efficient cooking of said food.

7. The assembly of claim 6 wherein said food cage has a triangular cross section and wherein during cooking an apex of said triangular cage is positioned between selected linear rods of said grid thereby positioning a portion of said food cage below the plane of said grill.

8. The assembly of claim 7 wherein said food cage is comprised of three longitudinal elongated planar sides;
a first side pivotally connected at one edge to a first edge of a second side, the other edge of said second side pivotally connected to a first edge of a third side, the other edge of said third side including means for releasable connecting the other edge of said first side when said first and said third sides are pivoted to form a triangle.

9. The assembly of claim 4 wherein said food cage has an equilateral triangular cross section.

10. The assembly of claim 4 wherein said food cage has a circular cross section and wherein during cooking a portion of said circular cage is positioned between a pair of said rods of said grid whereby a portion said circular food cage appears below the plane of said grill.
